(19) United States
(12) Patent Application Publication
(10) Pub. No.: US 2015/0054346 A1
(43) Pub. Date: Feb. 26, 2015

(54) WIRELESS-POWERED ELECTRONIC DEVICE AND WIRELESS POWER SUPPLY DEVICE THEREOF

(71) Applicants: KUO-CHIH HUANG, NEW TAIPEI CITY (TW); CHIH-JEN LIN, NEW TAIPEI CITY (TW)

(72) Inventors: KUO-CHIH HUANG, NEW TAIPEI CITY (TW); CHIH-JEN LIN, NEW TAIPEI CITY (TW)

(21) Appl. No.: 14/061,844

(22) Filed: Oct. 24, 2013

(30) Foreign Application Priority Data
Aug. 22, 2013 (TW) 102215744

(51) Int. Cl. H02J 5/00; H01F 38/14

(52) U.S. Cl. CPC H02J 5/005; H01F 38/14
USPC 307/104

(57) ABSTRACT

A wireless power supply device is adapted to a main body of an electronic device. The main body of the electronic device defines a power receiving compartment where the wireless power supply device is received. The wireless power supply device includes a wireless power receiver having a circuit board and a sensing coil. The sensing coil is disposed on and electrically connected to the circuit board, and the circuit board has two wires. The wireless power supply device also includes a shell conforming to the power receiving compartment. The shell has an anode portion and a cathode portion, the anode portion corresponds to an anode in the power receiving compartment and the cathode portion corresponds to a cathode in the power receiving compartment. The two wires respectively connect to the anode portion and cathode portion of the shell.

### BACKGROUND

1. Field of the Invention

The instant disclosure relates to a power supply structure; in particular, to a wireless power supply device.

2. Description of Related Art

Currently, toy development has advanced along with technology. A toy being capable of interaction with the people is very much desired. An interactive toy responds according to the stimuli. The fun is doubled, and the toy provides an alternative company and comfort.

However, interactive toys consume relatively more energy than traditional toys. The battery runs out fairly fast and frequent replacement is required. Many personalized settings have to be reconfigured after reboot which can cause unnecessary inconvenience.

To address the above issues, the inventor strives via associated experience and research to present the instant disclosure, which can effectively improve the limitation described above.

### BRIEF SUMMARY OF THE INVENTION

The instant disclosure provides a wireless power supply device for saving to replace the battery.

According to one exemplary embodiment of the instant disclosure, the wireless power supply device is adapted to a main body of an electronic device. The main body of the electronic device defines a power receiving compartment where the wireless power supply device is received. The wireless power supply device includes a wireless power receiver having a circuit board and a sensing coil. The sensing coil is disposed on and electrically connected to the circuit board, and the circuit board has two wires. The wireless power supply device also includes a shell conforming to the power receiving compartment. The shell has an anode portion and a cathode portion, the anode portion corresponds to an anode in the power receiving compartment and the cathode portion corresponds to a cathode in the power receiving compartment. The two wires respectively connect to the anode portion and cathode portion of the shell.

According to another embodiment of the instant disclosure, a wireless-powered electronic device is also provided. The wireless-powered electronic device includes a main body defining a power receiving compartment and having an anode and a cathode arranged in the power receiving compartment. The wireless power supply device includes a wireless power receiver having a circuit board and a sensing coil. The sensing coil is disposed on and electrically connected to the circuit board, and the circuit board has two wires. The wireless power supply device also includes a shell conforming to the power receiving compartment. The shell has an anode portion and a cathode portion, the anode portion corresponds to an anode in the power receiving compartment and the cathode portion corresponds to a cathode in the power receiving compartment. The two wires respectively connect to the anode portion and cathode portion of the shell.

The wireless power supply device can be adapted to any size and shape of a power receiving compartment because the shell is designed to conform to the power receiving compartment. The existing main body of the electronic device does not need to be changed, and the wireless power supply device can replace the traditional, disposable battery.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE SEVERAL VIEWS OF THE DRAWINGS

FIG. 1 is an exploded view of an electronic device capable of accepting wireless power supply;

FIG. 2 is another exploded view of an electronic device capable of accepting wireless power supply;

FIG. 3 is a perspective view of a wireless power supply device; and

FIG. 4 is a perspective view of a wireless-powered electronic device.

### DETAILED DESCRIPTION OF THE INVENTION

The aforementioned illustrations and following detailed descriptions are exemplary for the purpose of further explaining the scope of the instant disclosure. Other objectives and advantages related to the instant disclosure will be illustrated in the subsequent descriptions and appended drawings.

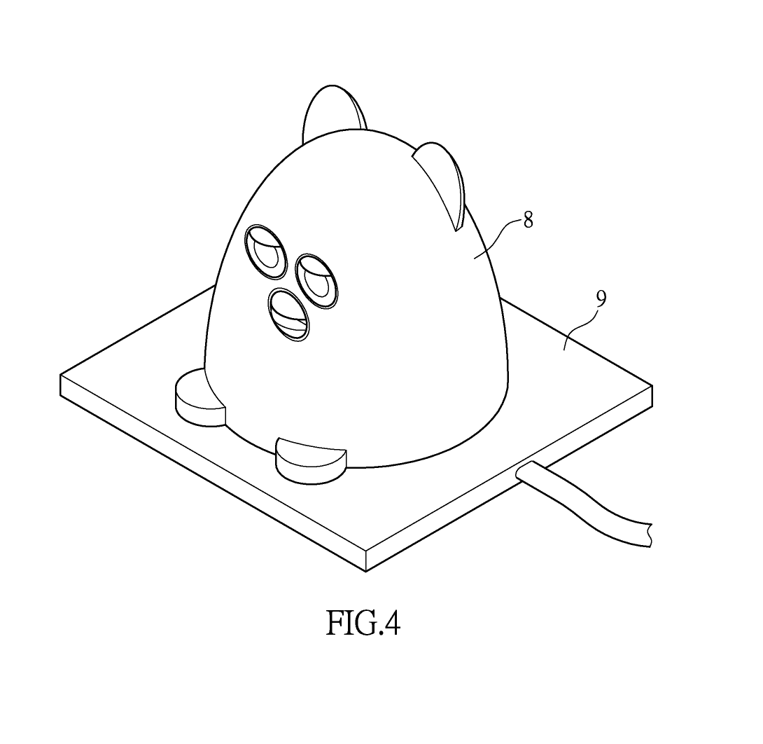

Please refer to FIG. 4. The instant disclosure provides an electronic device 8 which can accept wireless power supply. When the electronic device 8 is disposed on a wireless power supply panel 9, the electronic device 8 is powered.

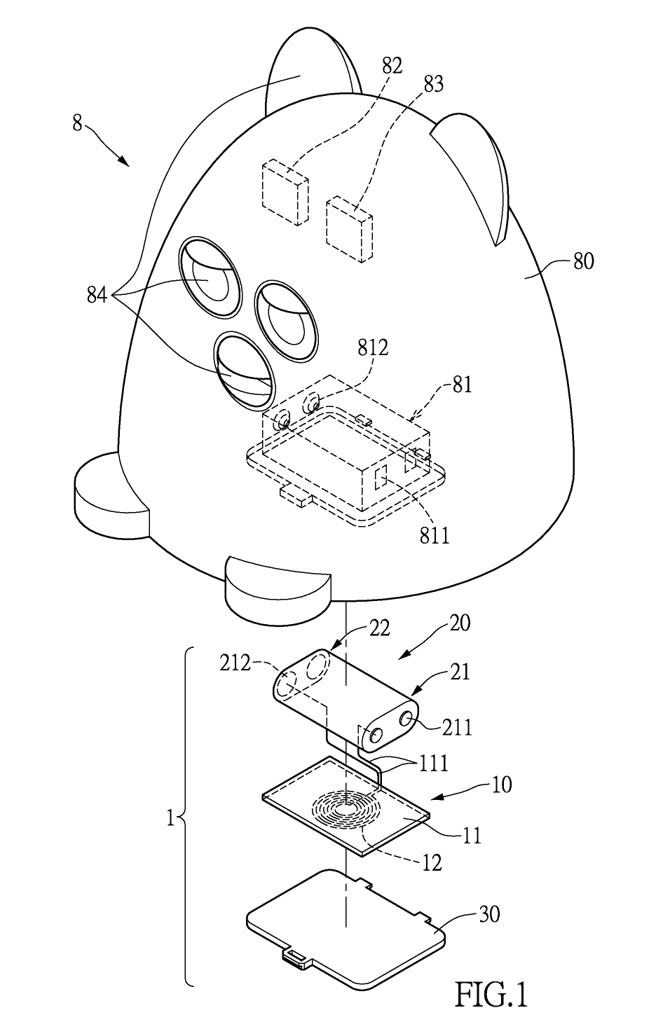

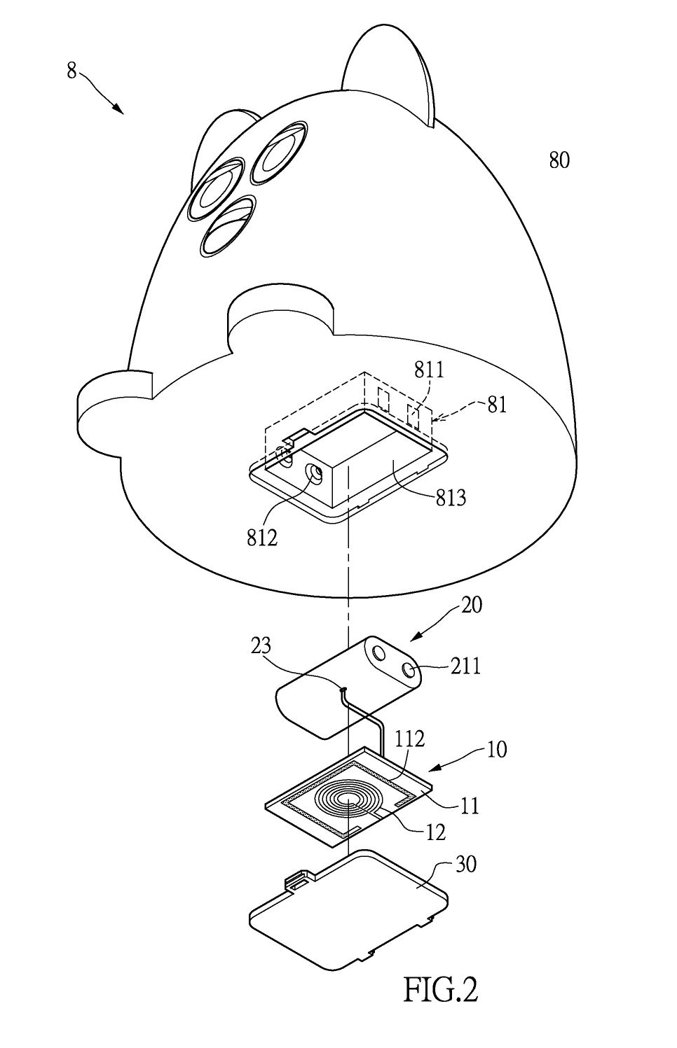

Please refer to FIG. 1 in conjunction with FIG. 2. The electronic device 8 includes a main body 80 and a wireless power supply device 1. The wireless power supply device 1 is disposed in the main body 80 and a portion thereof is exposed to the exterior. In the instant embodiment, the main body 80 is a pet like toy. The main boy 80 includes a microprocessing unit 82, an execution unit 84 and a signal receiving unit 83. The toy receives external signals, for example, sound, temperature or contacting, through the signal receiving unit 83. Then the signal receiving unit 83 passes on the signal to the microprocessing unit 82 which commands the execution unit 84. The pet like toy responds according to external stimuli. The responses include blinking, making noise, moving or the like. The responses may vary according to design requirement and the instant disclosure is not limited thereto. The main body 80 may also be a mouse, a robot or a telephone that requires constant power supply when resting on a surface.

The main body 80 defines a power receiving compartment 81 which is close to the wireless power supply panel 9. An anode 811 and a cathode 812 are disposed in the power receiving compartment 81. The position of the anode 811 and the cathode 812 is configured according a conventional battery layout. The power receiving compartment 81 is accessed through an opening 813, such that the wireless power supply device 1 can be placed in the power receiving compartment 81.

Please refer to FIGS. 1 and 2. The wireless power supply device 1 includes a wireless power receiver 10 and a shell 20. The wireless power receiver 10 is connected to the shell 20. The wireless power receiver 10 includes a circuit board 11 and a sensing coil 12. The sensing coil 12 is electrically connected to and disposed on one side of the circuit board 11. The circuit board 11 has two wires 111. The two wires 111 respectively allow connection with provide positive voltage and negative voltage.

The shape of the shell 20 conforms to the power receiving compartment 81 and can be put therein via the opening 813. The shell 20 is made of insulation material, for example, plastic, such that a user does not get electrical shock when installing the shell 20. The shell 20 is formed with a wire hole 23 and an anode portion 21 and a cathode portion 22. When mounted in the power receiving compartment 81, the anode portion 21 corresponds to the anode 811 while the cathode portion 22 corresponds to the cathode 812. In the instant embodiment, the power receiving compartment 81 is designed to receive alkaline battery, and therefore the shell 20 resembles a conventional alkaline battery which is a cylindrical tube and the anode portion 21 and the cathode portion 22 are arranged at the opposite side of the shell 20. The wire hole 23 is formed on the tube body of the shell 20.

The two wires 111 of the circuit board 11 go through the wire hole 23, such that the anode end and the cathode end of the wires 111 are received by the shell 20 and correspond to the anode portion 21 and the cathode portion 22 of the shell 20. In the instant embodiment, metal sheets 211, 212 are disposed on the outer side of the anode portion 21 and the cathode portion 22. The two wires 111 go through the shell 20 and contact the two metal sheets 211, 212, such that electricity channels are established to the anode portion 21 and the cathode portion 22. The wires 111 may also go through the shell 20 and arranged on the outer side of the anode and cathode portions 21, 22. The instant disclosure is not limited to the abovementioned configuration. Alternatively, the two wires 111 may also wrap along the shell 20 and reach the anode portion 21 and cathode portion 22 respectively.

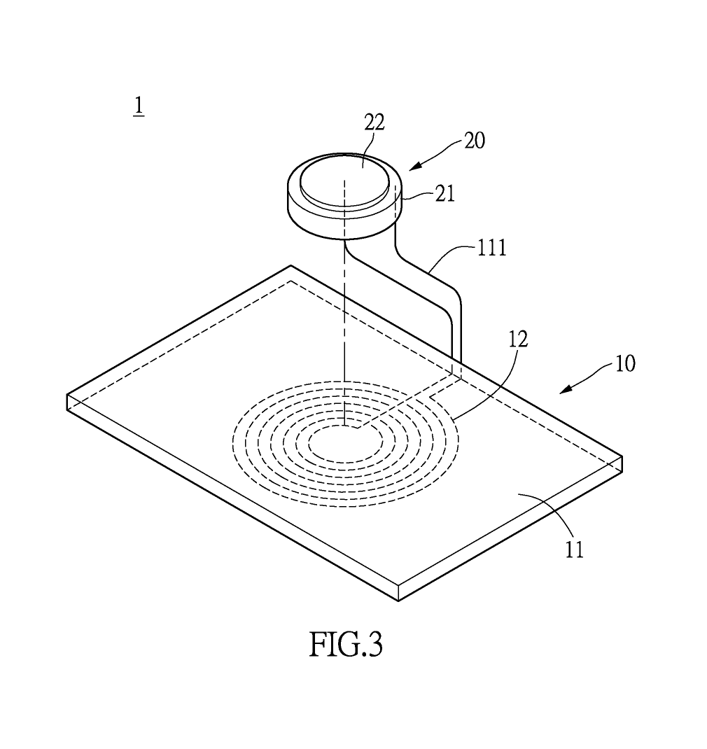

Please refer to FIG. 3. In another embodiment of the instant disclosure, the power receiving compartment 81 is shaped as a button battery. As a result, the shell 20 resembles a conventional button battery like a coin. The cathode portion 22 is arranged on one side of the shell 20 while the anode portion 21 is arranged on the remaining surface of the shell 20. The wire hole 23 is formed on the other side of the shell 20.

Attention is now invited to FIGS. 1 and 2. The wireless power supply device 1 is disposed in the power receiving compartment 81 of the main body 80. The opening 813 provides the access to the power receiving compartment 81. The wireless power receiver 10 is disposed between the outer cover 30 and the main body 80. The outer cover 30 closes up the opening 813, such that the power receiver 10 is secured within the power receiving compartment 81. The outer cover 30 is fastened to the main body 80 by bolts or screws. The circuit board 11 may have an attachment portion 112 on the side facing the outer cover 30. Then the outer cover 30 can be attached to the circuit board 11. Furthermore, the circuit board 11 of the power receiver 10 may be configured to block the opening 813. In this regard, the circuit board 11 replaces the outer cover 30 and functions as an electrical component and a cover at the same time.

Please refer to FIG. 4. When the electronic device 8 is disposed on the wireless power supply panel 9, the sensing coil 12 generates electrical current because of the electromagnetic effect between the power supply panel 9 and the sensing coil 12. The electrical current generated by the sensing coil 12 goes through the circuit board 11, wires 111 to the anode portion 21 and the cathode portion 22 of the shell 20 and finally to the anode 811 and cathode 822 in the power receiving compartment 81. The power is then provided to the microprocessing unit 82, execution unit 84 and signal receiving unit 83 of the main body 80.

In short, the wireless-powered electronic device and the wireless power supply device of the instant disclosure provide the following advantages. The shell can be adapted to various dimension of the power receiving compartment, such that the electronic device does not need to be remodeled. The wireless power supply module can replace the existing power supply mode. The sensing coil is exposed, and therefore the sensitivity is higher.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A wireless power supply device for connecting a main body of an electronic device, the main body of the electronic device defining a power receiving compartment, the wireless power supply device comprising:
a wireless power receiver having a circuit board and a sensing coil, wherein the sensing coil is disposed on and electrically connected to the circuit board, and the circuit board has two wires;
a shell conforming to the power receiving compartment, wherein the shell has an anode portion and a cathode portion, the anode portion corresponds to an anode in the power receiving compartment and the cathode portion corresponds to a cathode in the power receiving compartment;
wherein the two wires respectively connect to the anode and cathode of the shell.

2. The wireless power supply device according to claim 1, wherein one end of the two wires is embedded in the shell, and the two wires are arranged to go through the anode and cathode respectively.

3. The wireless power supply device according to claim 2, wherein the shell resembles a cylindrical tube, a wire hole is formed on the shell, the anode and cathode portions are arranged on the opposite side of the shell, and the two wires go through the wire hole.

4. The wireless power supply device according to claim 3, wherein the anode and cathode have a metal sheet respectively, and the two wires contact the metal sheet of the anode and cathode respectively.

5. The wireless power supply device according to claim 2 further comprising an outer cover, wherein the outer cover conforms to an opening of the power receiving compartment and the wireless power receiver is sandwiched between the shell and the outer cover.

6. The wireless power supply device according to claim 5, wherein the sensing coil is disposed on one side of the circuit board that is closer to the outer cover.

7. The wireless power supply device according to claim 5, wherein one side of the circuit board that is closer to the outer cover has an attachment portion.

8. The wireless power supply device according to claim 2, wherein the circuit board conforms to the power receiving compartment.

9. A wireless-powered electronic device comprising:
a main body defining a power receiving compartment and having an anode and a cathode arranged in the power receiving compartment; and
a wireless power supply structure comprising:
a wireless power receiver having a circuit board and a sensing coil, wherein the sensing coil is disposed on and electrically connected to the circuit board, and the circuit board has two wires;
a shell conforming to the power receiving compartment, wherein the shell has an anode portion and a cathode portion, the anode portion corresponds to an anode in the power receiving compartment and the cathode portion corresponds to a cathode in the power receiving compartment;
wherein the two wires respectively connect to the anode and cathode of the shell.

10. The wireless-powered electronic device according to claim 9, wherein the main body is a pet-shaped toy.
